(19) United States
(12) Patent Application Publication
(10) Pub. No.: US 2002/0050472 A1
(43) Pub. Date: May 2, 2002

(54) Differential pressure filtering system having a cylindrical drum with dome-shaped ends

(75) Inventor: Steve McEwen, Bowling Green, OH (US)

Correspondence Address: The Pinehurst Office Center, Suite 101, 39400 Woodward Avenue, Bloomfield Hills, MI, 48304-5151, US

(73) Assignee: Henry Filters, Inc.

(21) Appl. No.: 09/900,782

(22) Filed: Jul. 6, 2001

Related U.S. Application Data
(60) Provisional application No. 60/216,574, filed on Jul. 7, 2000.

(51) Int. Cl. B01D 29/96

(52) U.S. Cl. 210/387; 210/445; 210/450; 210/455

(57) ABSTRACT

A differential pressure filtering system for removing debris from a fluid includes a generally cylindrical drum having a top shell and a bottom shell. An inlet port receives pressurized fluid into the drum. A filter medium is sandwiched between the top and bottom shells for filtering the fluid. A screen is disposed across the bottom shell for supporting the filter medium. An outlet port discharges filtered fluid from the drum. The top and bottom shells have generally rounded end portions which align to form a pair of domed drum ends for providing structural rigidity to withstand pressure created in the drum by the pressurized fluid. In a preferred embodiment, the pressure filtering system provides a filter cleaning operation utilizing cylinders and quick clamp mechanisms externally mounted on opposing sides of the drum to open and close the top and bottom shells. An O-ring seals the top and bottom shells in the closed position.

### CROSS-REFERENCE TO RELATED APPLICATIONS

This application claims the benefit of U.S. Provisional Patent Application Serial Number 60/216,574, filed Jul. 7, 2000.

### FIELD OF THE INVENTION

This invention relates to a pressure filtering system and more particularly to a pressure filtering system having a generally cylindrical drum with generally dome-shaped ends.

In one embodiment of the present invention, the filtering system is cylindrical and has dome-shaped ends. In a second embodiment, the filtering system is octagonal with an eight-sided end cap on each end. The latter embodiment approaches a cylinder, but because it is eight-sided, is easier to manufacture, while still providing the benefits of a cylindrical drum. Although not shown, a six-sided drum or a drum with more than eight sides is also within the scope of the present invention.

### BACKGROUND OF THE INVENTION

Pressure filtering systems utilize pressure to force a fluid or liquid containing debris through a filter. Typically, heavy-duty pressure filtering systems are used in industry to quickly clean large quantities of coolant or cutting fluid containing dirt and metal debris. These heavy-duty pressure filtering systems are commonly referred to as flat bed pressure filters. An example of a typical flat bed pressure filter is illustrated in FIG. 1. A major disadvantage of flat bed filters is that they require a super structure over the flat beds to support air bellows which apply force to the flat beds to keep them closed. The super structure also provides structural support to the flat beds to resist the inherent bulging of the beds when pressurized. Another disadvantage of flat bed filters is the higher stress concentration at the comers where there is a bend. Fatigue failures occur at these corners as pressure is changed through opening and closing of the flat bed filters.

Flat bed pressure filters typically include two horizontally stacked chambers, commonly referred to as an upper chamber and a lower chamber. The upper and lower chambers are separated by a filter medium. Dirty liquid is introduced into the upper chamber at pressures which gradually rise as a cake of filtered-out debris accumulates on the filter medium. The fluid is pumped through the filter medium and into the lower chamber. The fluid in the lower chamber is then pumped and/or drained to a holding tank or reservoir. The holding tank contains enough clean fluid to supply all the equipment associated with the flat bed pressure filter during the period of time required to index the filter medium in the flat bed pressure filter. In other words, the reservoir must be large enough to supply fluid to the equipment during normal shut down of the flat bed pressure filter.

Over time, the cake of filtered-out debris accumulates to a thickness which unduly impedes fluid flow through the filter. As a result, the filter medium must be periodically cleaned. The cleaning process involves lifting the upper chamber and advancing the filter medium to discharge the filter medium having the accumulated cake and index a clean section of filter medium between the chambers. After the filter medium is indexed, the upper chamber is lowered and sealed against the lower chamber. During this process, the reservoir is the only source of fluid to the equipment. Therefore, an accurately timed cleaning process is required and an accurately sized reservoir is needed.

Although prior art pressure filters sufficiently clean most fluids, they have several shortcomings. Foremost, prior art pressure filters employ a rectangular-shaped housing having inherent structural deficiencies. Specifically, the rectangular-shaped housing has a tendency to naturally bow or distort outwardly in response to internal pressure. To counteract this tendency, the rectangular-shaped housing requires additional reinforcement such as a super structure to withstand pressure. Further, prior art pressure filters employ complex chamber sealing systems that are expensive to manufacture and difficult to repair. Furthermore, prior art pressure filters require a reservoir to hold fluid during indexing adding cost to the system and requiring valuable floor space. Accordingly, it is desirable to provide a pressure filtering system which overcomes the shortcomings of the prior art.

### SUMMARY OF THE INVENTION

In a disclosed embodiment of this invention, a pressure filtering system for removing debris from a fluid includes a generally cylindrical drum having a top shell and a bottom shell. Reference to a generally cylindrical drum includes a cylinder and all shapes that approach a cylinder, such as a multiple-sided vessel approaching a cylinder. Such a vessel is disclosed in the second embodiment of the present invention which is an eight-sided vessel.

Pressurized fluid is pumped into the drum through an inlet port. It should be noted that as an alternative, fluid could be allowed to enter by gravity or pumped into the upper half and a pump connected to the lower half to evacuate and create a negative pressure thereby increasing the differential across the medium and still not exceeding a certain predetermined internal pressure. Additionally, a pump could be used at the inlet and an evacuation pump at the outlet, if desired. A filter medium is sandwiched between the top and bottom shells for filtering the fluid. A screen is disposed across the bottom shell for supporting the filter medium. An outlet port discharges filtered fluid from the lower half of the drum. It should be understood that the inlet and outlet ports are on opposite sides of the filter medium. The top and bottom shells have rounded end portions or end portions having a shape that approaches round. These end portions align to form a pair of domed drum ends for providing structural rigidity to withstand the pressure created in the drum as the pressurized fluid is forced through the filter medium.

An important advantage of the vessel of the present invention is the lower cost to manufacture. Due to the generally cylindrical shape of the vessel, there is no need for the super structure or the bellows. The generally round vessel does not require a super structure to resist bowing and bulging. Furthermore, the bellows are not needed to hold the top shell to the bottom shell.

Another important advantage of the present invention is its ability to be used as an in-line filter. With in-line filters, there is no down time when indexing the filters which obviates the need for a fluid reservoir and the associated pumps, greatly reducing the cost and the space required for the filter system.

In-line filters allow one of the filters to be taken off-line for indexing of the filter paper while the other filter continues to filter the fluid. Typical filter systems require the line to be shut down during indexing of the filter paper or to employ a reservoir to contain enough clean fluid to allow operation of equipment while the indexing process is taking place. A typical reservoir is very large and must contain a substantial amount of fluid. For example, if 1000 gallons per minute is required to supply the equipment and it takes 4 minutes to index the filter, the reservoir must hold at least 4000 gallons of fluid. As can be appreciated, a reservoir containing 4000 gallons of liquid requires a fairly substantial structure, takes up a fair amount of space and requires a pump to pump the fluid from the reservoir to the equipment at the desired pressure. The use of in-line filters eliminates the need for these large costly reservoirs.

Standard rectangular pressurized fluid filters cannot economically be used in-line. The main problem is that a standard rectangular fluid filter cannot contain the pressure required to use the system in-line. As should be appreciated by those of ordinary skill in the art, without a reservoir, the fluid must exit the filter at the pressure required by the equipment. Typically, the equipment requires fluid at 30 to 40 psi. Therefore, the fluid has to be pumped into the filter at 30 to 40 psi to adequately supply the equipment. Furthermore, even higher pressures are required in the filter as the cake develops because of the pressure differential across the filter paper due to the cake. The pressure differential will normally be about 10 psi, requiring the pressure into the filter to be between 40 to 50 psi. A rectangular pressure vessel cannot economically or practically contain these high pressures. A rectangular vessel typically can only contain pressures of about 15 psi maximum. Due to the cylindrical shape of the fluid filter of the present invention, pressures of about 100 psi can be contained. The ability to contain these higher pressures allows the pressure vessel of the present invention to be used in-line with the all the advantages that result from an in-line system.

The cylindrical fluid filter of the present invention also allows a vacuum to be drawn in the cylinder to facilitate the drying of the cake on the filter paper. By connecting a vacuum pump to the cylindrical fluid filter (preferably to the lower half), a vacuum can be drawn within the pressure filter reducing the time required to dry the filter. With a vacuum applied, the temperature at which the liquid within the filter paper gasses is much less allowing for a very short evaporation time of the liquid (during the time heat may be required to replace heat lost due to evaporative cooling).

In a preferred embodiment, the pressure filtering system provides a filter cleaning operation utilizing cylinders and quick clamp mechanisms externally mounted on opposite sides of the drum to open and close the top and bottom shells. An O-ring seals the top and bottom shells in the closed position. The O-ring is easy to replace when compared to prior art devices. This reduces manufacturing costs and maintenance costs. To further reduce cost and facilitate service and maintenance of the pressure filtering system, the support screen is preferably made from a plurality of removable modular sections.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a partially exploded, perspective view of a pressure filtering system in accordance with the present invention;

FIG. 2 is a side view of the pressure filtering system shown in a closed or filtering position;

FIG. 3 is a side view of the pressure filtering system shown in an opened or indexing position;

FIG. 4 is a cross-sectional side view of the pressure filtering system showing the internal structure of the system;

FIG. 5 is an enlarged view of a cylinder and quick clamping mechanism of the pressure filtering system;

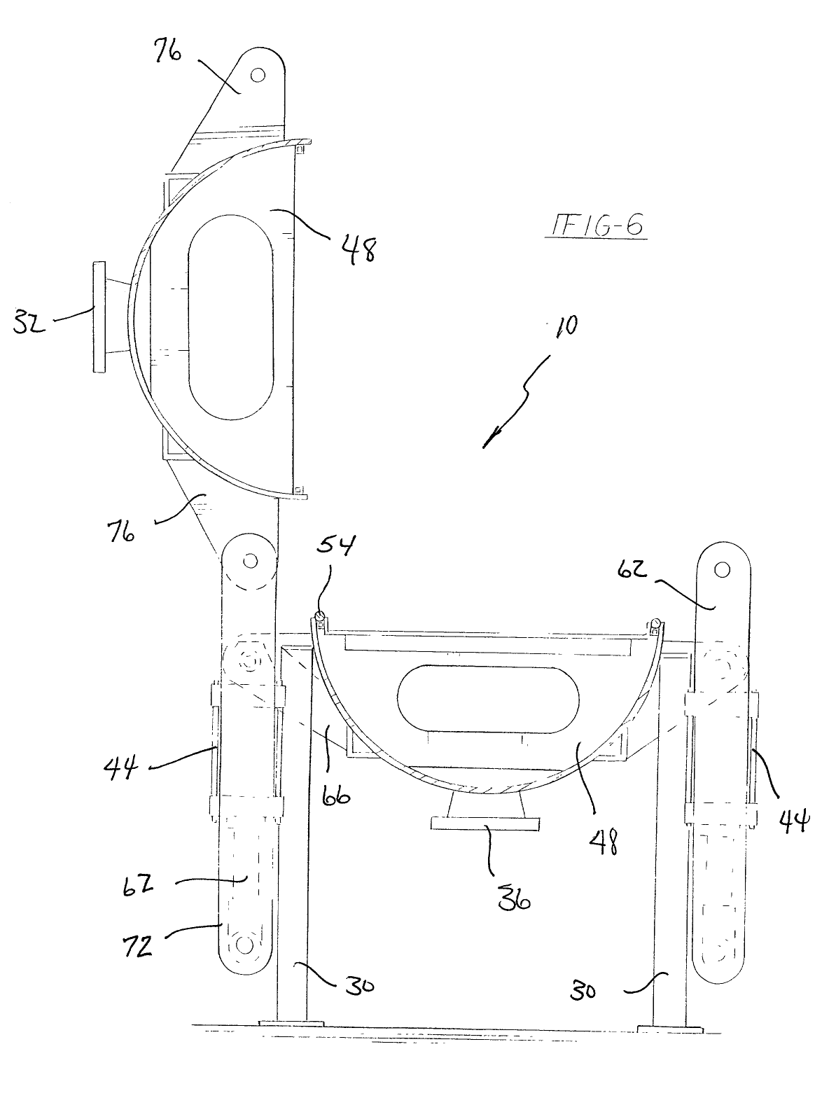

FIG. 6 is a perspective view of the filtering system with the top hinge open;

FIG. 7 is a perspective view of a further embodiment of the present invention having eight sides forming a generally cylindrical pressure filtering system; and,

FIG. 8 is a schematic view of an inline system.

### DETAILED DESCRIPTION OF THE PREFERRED EMBODIMENT

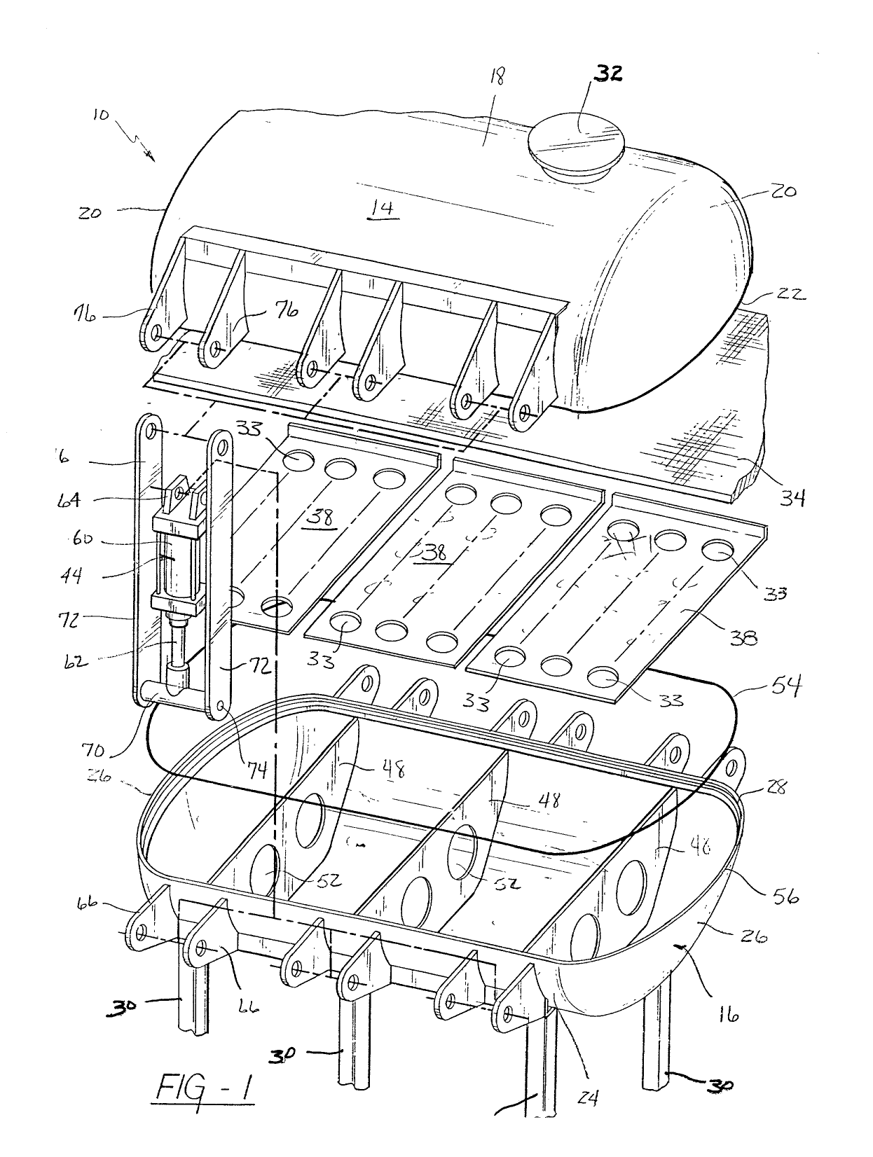

Referring to the Figures, wherein like numerals indicate like or corresponding parts throughout the several views, a partially exploded, perspective view of a pressure filtering system 10 is shown in FIG. 1. The pressure filtering system 10 is adapted to remove debris, such as dirt or metal shavings, from a fluid or liquid, such as a cooling or lubricating fluid. The pressure filtering system 10 includes a cylindrical drum 12 formed by the union of a top shell 14 and a bottom shell 16.

The top shell 14 includes a first semi-cylindrical body portion 18 and rounded end portions 20. An upper peripheral lip 22 is disposed about the perimeter of the first body portion 18 and the rounded end portions 20. The bottom shell 16 includes a second semi-cylindrical body portion 24 and rounded end portions 26. A lower peripheral lip 28 is disposed about the perimeter of the second body portion 24 and the rounded end portions 26. The bottom shell 16 also includes a plurality of legs 30 adapted to support the filtering system 10 on a floor or surface.

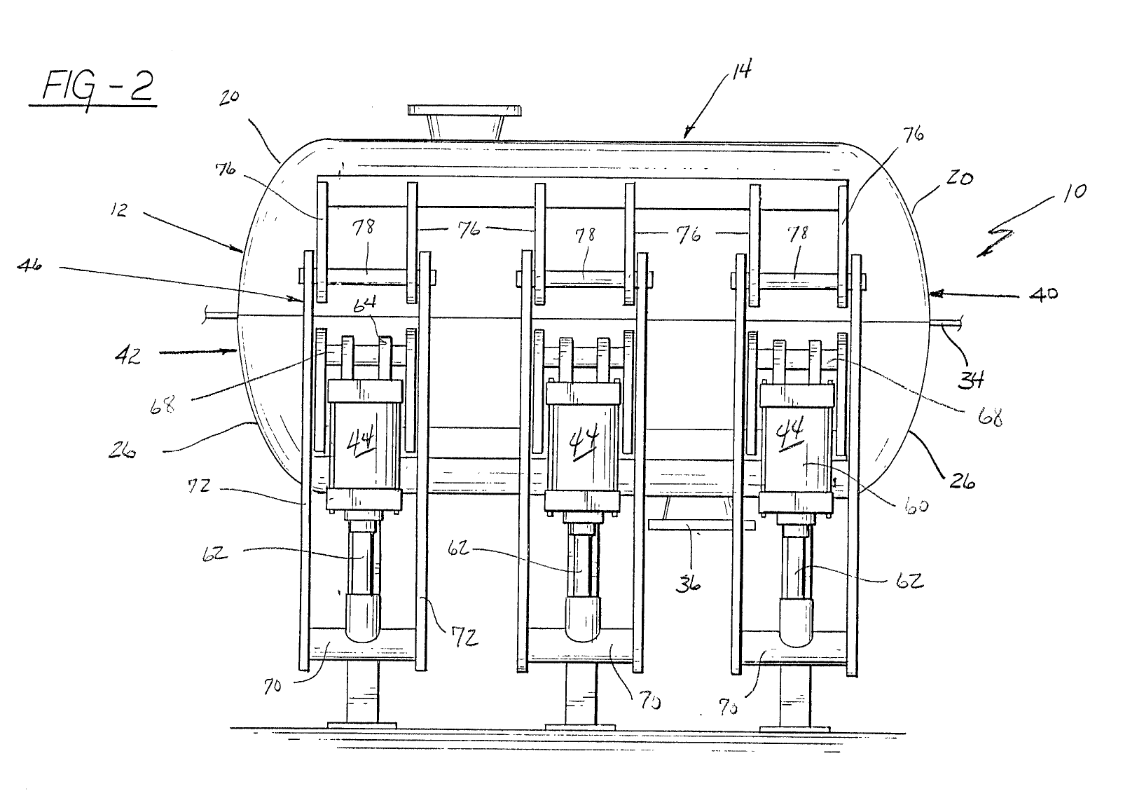

The top shell 14 includes an inlet port 32 adapted to receive pressurized fluid into the drum 12. It should be understood that the inlet may receive fluid by gravity and a vacuum pump would then draw fluid through the filter or that the fluid may enter from the bottom and exit through the top. A filter medium 34 is sandwiched between the top and bottom shells 14, 16 for filtering debris from the fluid. The filter medium 34 is adapted to screen or prevent debris from entering into the bottom shell 16. Accordingly, the bottom shell 16 functions as a reservoir for clean or filtered fluid. To discharge the filtered fluid, the bottom shell 16 includes an outlet port 36 (see FIG. 2). During the filtering process, a cake or layer of filtered debris accumulates on the top surface of the filter medium 34.

The filter medium 34 may be any type of media known by one of ordinary skill in the art. The filter medium 34 can be a disposable medium which is preferably roll-fed through the drum 12. With disposable medium, the medium having a cake is indexed out of the cylinder and disposed of with a new section of medium taking its place in the drum 12. The filter medium 34 can also be reusable. With reusable medium, a continuous medium loop is created that is indexed through the drum 12. The cake is preferably scraped off the medium by a scraper device and then drawn through a solution to clean the medium.

In the preferred embodiment, a plurality of screens 38 are disposed across the bottom shell 16 to support the filter medium 34. Moreover, the screens 38 sustain the force of the pressure differential across the debris cake accumulated on the top surface of the filter medium 34. Typically, the screen 38 is a perforated metal plate having a plurality of small holes 33 formed in it to allow the filtered fluid to pass through to the outlet 36.

In the preferred embodiment, the screens are approximately 2 feet by 3 feet, and if desired, screens having a contour to fit the shape of the domes 26, i.e., having one circular end, could be used. The preferred filter 10 would be made from incremental modular lengths such as 2 foot lengths, to any desired length. The screens are 2 foot long to fit this modular construction and to allow for easy maintenance by being easily removable.

FIG. 2 is a side view of the pressure filtering system 10 showing the drum 12 in a closed or filtering position. When the drum 12 is closed, the filtering system 10 operates to pump fluid into the top shell 14 and through the filter medium 34. In the closed position, the rounded end portions 20 and 26 of the top and bottom shells 14 and 16 align to form a pair of domed drum ends 40 and 42. The overall round cylinder with domed-shaped ends provides structural rigidity to withstand the pressure created when the pressurized fluid is forced through the filter medium 34. Unlike known filters, the pressure filtering system of the present invention does not require tremendous force over a large area of the filter to keep the filter closed or a complex support structure. The present invention merely requires enough force around the periphery to hold the top 14 down and a minimal amount of support structure due to the cylindrical shape.

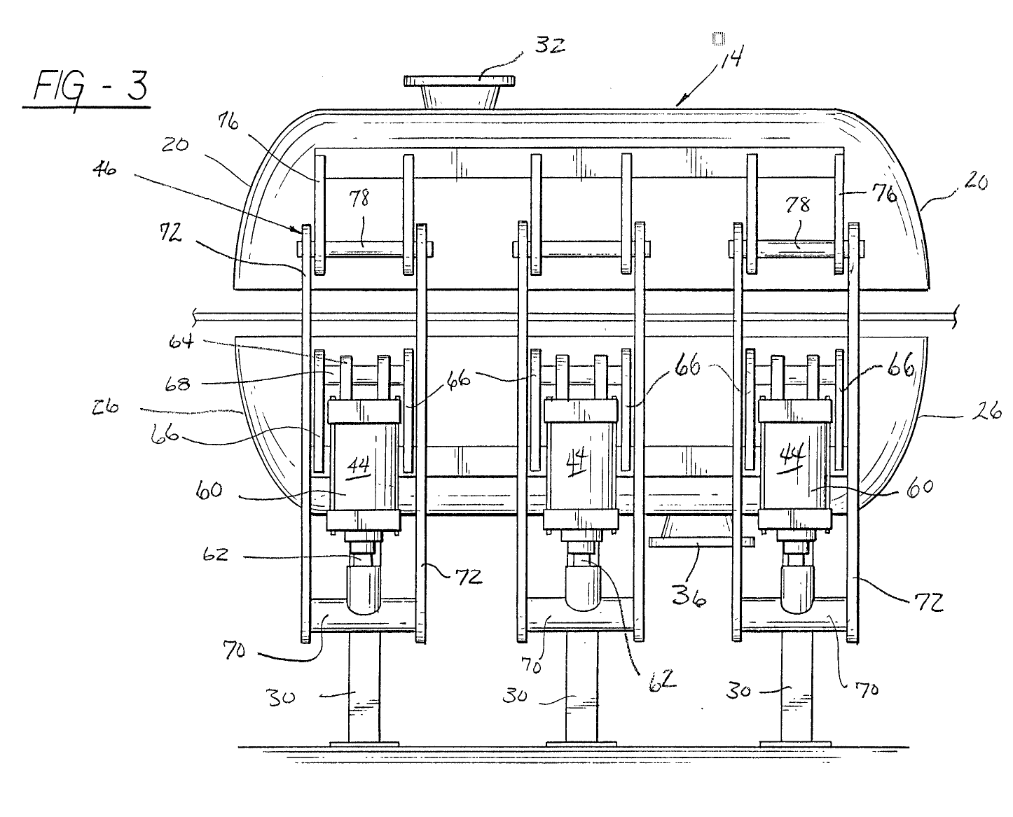

A plurality of cylinders 44 and quick clamping mechanisms 46 are externally mounted on opposing sides of the drum 12. The cylinders 44 and quick clamping mechanisms 46 are adapted to move the top and bottom shells 14 and 16 between the closed position and an opened position. In FIG. 2, the cylinders 44 are illustrated in the extended position which closes the vessel. In FIG. 3, the cylinders 44 are in the retracted position which opens the vessel.

It should be appreciated that the quick release clamp could, for example, be an over-the-center clamp. With over-the-center clamps, or toggle clamps, it is possible that cylinders would not be required.

The cylinders 44 are preferably hydraulic or pneumatic cylinders, depending on the forces required. Each cylinder 44 has a cylinder body 60 and rod 62. The cylinder body has mounting ears 64 for mounting to brackets 66 on bottom shell 16. The ears 64 are preferably pinned to brackets 66 by a removable pin 68. The pin 68 is removable so that the cylinder can be disconnected from the bottom shell 16 for maintenance, if necessary.

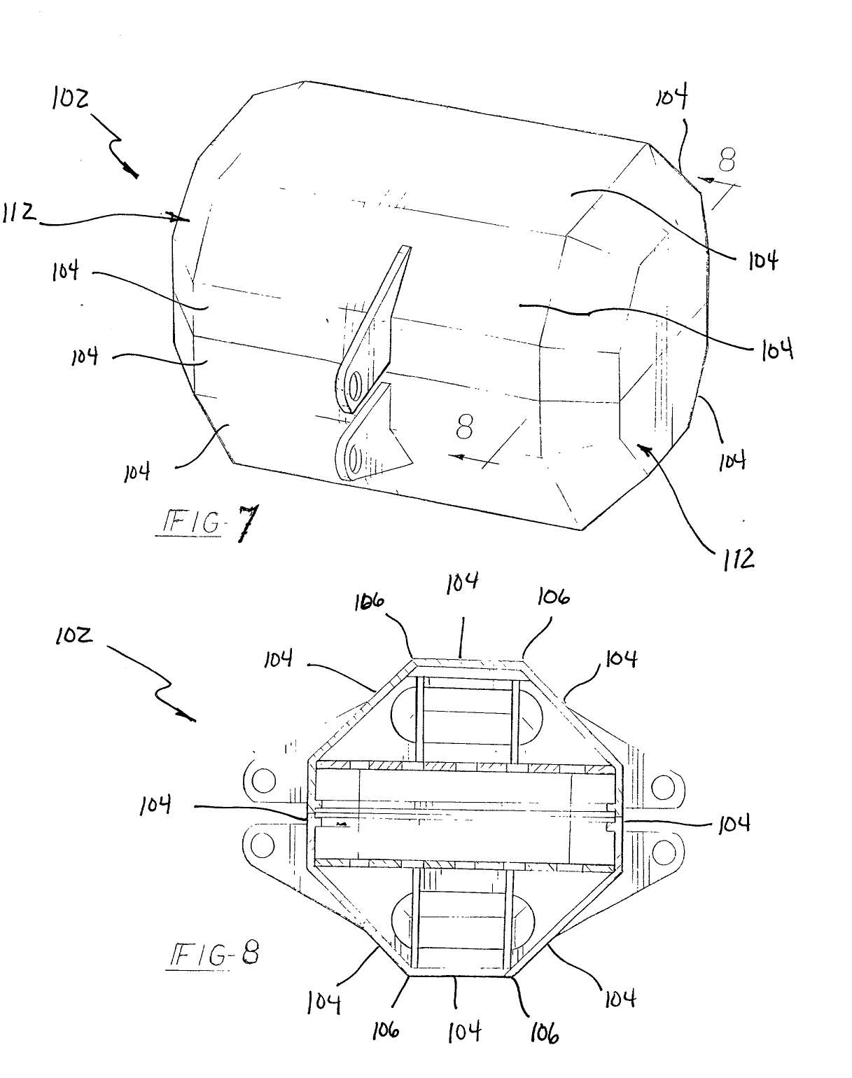

The rod 62 is connected to a coupler 70 which couples rod 62 to arms 72 through a journaled pin 74. The arms 72 extend up from the coupler 70 and are connected to brackets 76 on the top shell 14. The arms 72 are preferably pinned to the ears 76 by a removable pin 78. The pin 78 is removable to allow the cylinder mechanism to be quickly disconnected from the top shell 14 so that the top shell 14 can be moved to allow access to the interior of the bottom half 16. The top shell 14 can be raised and removed from the bottom shell 16 for maintenance. Additionally, the top shell 14 can be pivoted about the quick clamp mechanisms 46 on the opposite side of the drum 12. See FIG. 6. This greatly facilitates maintenance operations, such as screen cleaning or replacement.

The cylinders 44 are mounted so that when pressurized to close the top shell 14 to the bottom shell 16, the pressure is acting on the side of the cylinder plunger opposite the rod 62. In this way, there is nominal, if any, potential for fluid to leak around the seal about the rod 62. Therefore, once pressurized, the cylinder 44 can keep the two halves 14 and 16 sealed with minimal, if any, additional oil or air being pumped to the cylinders 44. Additionally, with the cylinders 44 positioned in this way, once pressurized, the inlet to the cylinders 44 can be closed and no more fluid needs to be added to keep the top 14 closed with respect to the bottom shell 16. With the inlet valve closed, the pressurized fluid in cylinders 44 act as a solid block resisting any opening of the top shell 14 with respect to the bottom shell 16. With this arrangement, the pressure filtering system 10 can use less expensive pumps to supply fluid to the cylinders 44. For example, an air and oil system could be used with air pushing hydraulic fluids. To open the top shell 14, fluid is pumped to the opposite side of the cylinder plunger to retract the rod and open the top shell 14. As will be appreciated, the pressure to open top half 14 is less than the pressure to close the unit.

FIG. 3 is a side view of the pressure filtering system 10 showing the drum 12 in the opened or indexing position with the cylinders 44 retracted. In the opened position, the top shell 14 is spaced from the bottom shell 16.

During the filtering process, the filter medium 34 accumulates a cake or layer of filtered debris. Over time, the cake increases to a thickness which unduly impedes fluid flow through the filtering system 10. As a result, the filtering system 10 must be periodically cleaned to remove the accumulated cake. To clean the filtering system 10, the drum 12 is opened by retracting cylinders 44 and the cake covered filter medium is replaced with a clean filter medium. Typically, a roll supply of filter medium 34 is advanced forward thereby indexing a clean portion of filter medium between top and bottom shells 14 and 16. Alternatively, the filter medium could be reusable. The use of a reusable medium requires the caked portion of the medium to be cleaned and prepared for re-indexing through the drum 12. With a reusable medium, the caked section of the medium is indexed through a cleaning station as the clean section is moved into position in the drum 12.

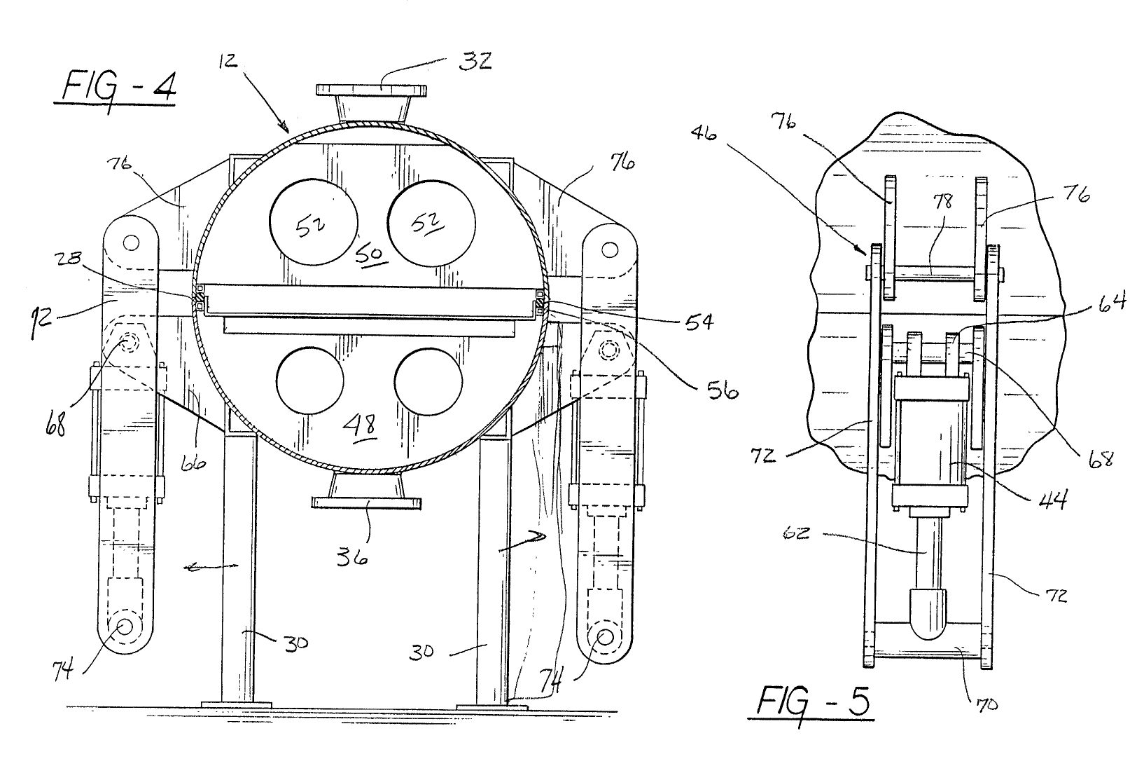

FIG. 4 is a cross-sectional side view of the pressure filtering system 10 showing an internal structure of the drum 12. A plurality of bulkheads 48 and 50 are transversely disposed within the top and bottom shells 14 and 16 to provide structural support to the drum 12 to resist pressure created within the drum 12. Each bulkhead 48 and 50 includes apertures 52 to facilitate fluid circulation within the drum 12. The bottom shell bulkheads 50 are also adapted to support the screens 38. An additional bulkhead can be added longitudinally within the top, bottom or both halves of the drum 12. The longitudinal bulkhead is not shown.

As best seen in FIGS. 1 and 4, an O-ring 54 is seated in a channel 56 in the lower peripheral lip 28 of the bottom shell 16. The O-ring 54 is used to seal the upper peripheral lip 22 of the top shell 14 to the lower peripheral lip 28 of the bottom shell 16 in the closed position.

The O-ring 54 greatly facilitates maintenance and greatly reduces both maintenance and manufacturing costs of the filtering system 10. Typically, rectangular filtering systems have fairly complex seals that are expensive to manufacture and difficult to replace. As will be appreciated by one of ordinary skill in the art, the O-ring 54 is merely inserted into the channel 56 when the filter 10 is manufactured. To replace the seal, the O-ring 54 is pulled from the channel 56 and a new O-ring 56 is inserted.

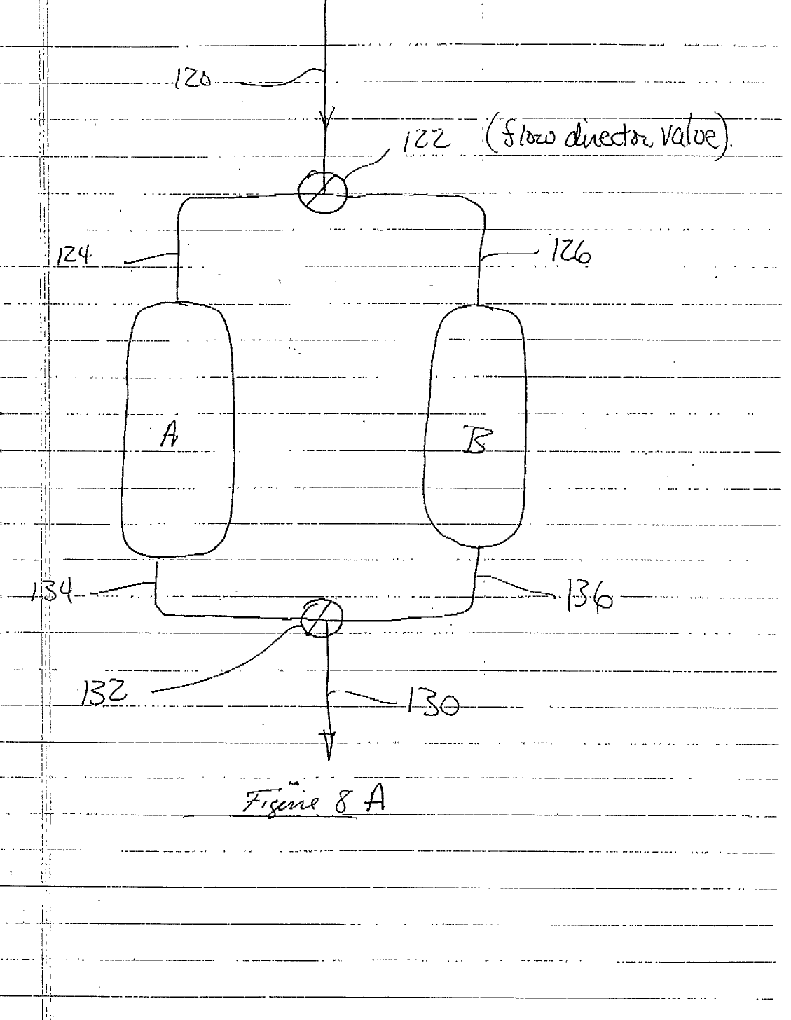

With reference to FIG. 7, a further embodiment of the drum 102 of the present invention is shown. The drum 102 of the second embodiment is generally cylindrical, but instead of being round, the cylinder 102 is made of eight sides 104. The sides 104 are joined at their edges 106 by, for example, welding. The ends 108 and 110 are constructed of plates 112 to form generally domed ends. Although the ends are not round like in the first embodiment, they closely approach the rounded dome ends 20, 26 of the first embodiment.

The drum 102 of this embodiment has all the features and advantages of the drum 12, since it does closely approach a round cylinder. However, the drum 102 is easier to manufacture due to the ability to cut the sides 104 and plates 112 from a sheet of steel and then weld the various pieces together or a single sheet of steel could be formed into the desired shape. It should be understood by those of ordinary skill in the art that the drum 102 would include the bulkheads 48, screen 38, seal 54, cylinders 44, clamping mechanisms 46, etc., see FIG. 9. In this view, additional longitudinal bulk heads are illustrated.

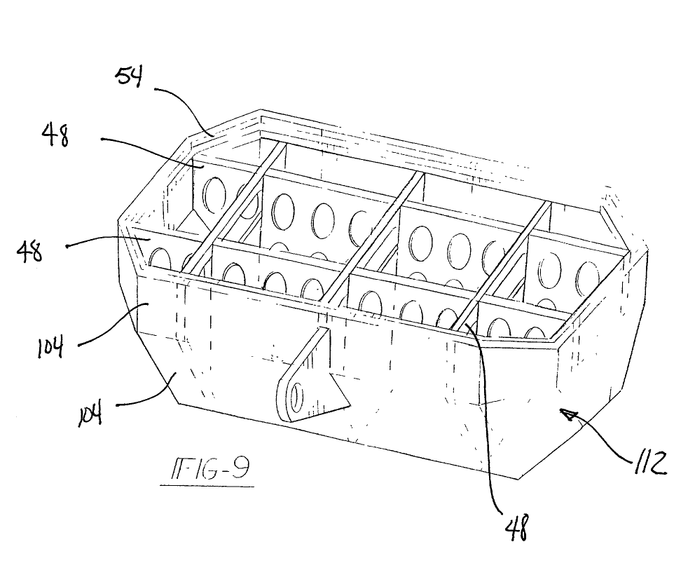

With reference to FIG. 8A, a schematic view of an example of an in-line filtering system of the present invention is illustrated. The filters A and B are shown parallel with inlet lines 120 and outlet lines 130. The inlet line 120 includes a flow directing valve 122 which directs the dirty fluid from the equipment to either filters A or B with the other filter being off-line. Connecting lines 124 and 126 connect the valve 122 with either filter A or B depending upon the position of the valve 122. The outlet line 130 has a flow directing valve 132 and connecting lines 134 and 136.

In use, the flow directing valves 122 and 132 are positioned to direct fluid flow in and out of either filter A or B, with the other filter being idle. While idle, the filters can be indexed, repaired, etc., without affecting the operation of the equipment. As will be appreciated, no reservoir is required.

When the filtering system of the present invention is used as an in-line filter, the inlet pressure must be adjusted to account for the pressure drop due to cake formation. As should be appreciated, the equipment being supplied fluid requires the fluid at a constant pressure. With the filter being in-line, the cake forming on the filter medium creates a pressure drop which would potentially affect equipment operation unless adjusted. To adjust the pressure, the valve position can be adjusted or the pump speed can be adjusted to accommodate for the drop in pressure. In the preferred embodiment, the adjustment would be done automatically through a sensor, sensing the pressure drop and signaling a control device to make the appropriate adjustment.

Another advantage of cylindrical drum 12, or 102 is the ability to pull a vacuum in the drum to dry the cake before indexing. In this way, the cake can be dried by vacuum distillation. In use, the fluid in the drum 12 or 102 is forced out. The inlet is then closed and a pump connected to the outlet draws a vacuum in drum 12, 102. Because of the generally cylindrical shape of the drum, the drum doesn't collapse due to the vacuum within the drum 12, 102. The vacuum within the drum 12, 102 causes the fluid in the cake to evaporate at low temperatures drying the cake. Once dried, the medium 34 is indexed as previously described.

The invention has been described in an illustrative manner, and it is to be understood that the terminology which has been used is intended to be in the nature of words of description rather than of limitation.

Obviously, many modifications and variations of the present invention are possible in light of the above teachings. For example, instead of pins 78, a quick release clamp could be used to connect arms 72 to brackets 76. It is, therefore, to be understood that within the scope of the appended claims, the invention may be practiced otherwise than as specifically described.

What is claimed is:

1. A differential pressure filtering system for removing debris from a fluid, the pressure filtering system comprising:
a generally cylindrical drum having a top shell and a bottom shell;
an inlet port for receiving pressurized fluid into said drum;
an outlet port for discharging filtered fluid from said drum, said top and bottom shells having generally rounded end portions aligning to form a pair of domed drum ends for providing structural rigidity to withstand pressure created in said drum as fluid is pumped into said filtering system and through a filter medium adapted to be sandwiched between said top and bottom shells.

2. A differential pressure filtering system as set forth in claim 1 wherein said top shell includes a first semi-cylindrical body portion and an upper peripheral lip disposed about said first body portion and said rounded end portions of said top shell and wherein said bottom shell includes a second semi-cylindrical body portion and a lower peripheral lip disposed about said second body portion and said rounded end portions of said bottom shell.

3. A differential pressure filtering system as set forth in claim 2 including a clamping assembly mounted on opposing sides of said drum for moving said top and bottom shells between an opened position wherein said top and bottom shells are spaced from each other and a closed position wherein said upper peripheral lip of said top shell abuts said lower peripheral lip of said bottom shell.

4. A pressure filtering system as set forth in claim 3 wherein each of said cylinders is externally mounted to said drum with a quick clamping mechanism.

5. A pressure filtering system as set forth in claim 3 wherein said cylinders include a body and rod with a plunger, said body receiving pressurized fluid on either side of said plunger to move said rod into and out of said cylinder, said cylinders being oriented such that fluid is pressurized against said plunger to force said plunger out of said cylinder when said top shell is in a closed position.

6. A pressure filtering system as set forth in claim 3 including an O-ring disposed between said upper peripheral lip of said top shell and said lower peripheral lip of said bottom shell to seal said drum in the closed position.

7. A pressure filtering system as set forth in claim 1 including a plurality of bulkheads transversely disposed within said top and bottom shells for providing structural support in said drum to resist pressure created to force fluid through said filter medium.

8. A pressure filtering system as set forth in claim 7 wherein each bulkhead includes apertures for facilitating fluid circulation within said drum.

9. A pressure filtering system as set forth in claim 7 further including at least one screen supported by said bulkheads disposed in said bottom shell for supporting said filter medium.

10. A pressure filtering system as set forth in claim 9 wherein said screen is defined by a plurality of removable modular sections.

11. A pressure filtering system as set forth in claim 1 wherein said filter medium is longitudinally indexed through said drum.

12. A pressure filtering system as set forth in claim 11 including a rolled supply of said filter medium and wherein debris covered filter medium is replaced by indexing said filter medium supply through said drum.
